(19) United States
(12) Patent Application Publication
(10) Pub. No.: US 2017/0305380 A1
(43) Pub. Date: Oct. 26, 2017

(54) PASSENGER SIDE AIRBAG AND AIRBAG APPARATUS HAVING THE SAME

(71) Applicants: Kei TSUJIMOTO, Shiga (JP); Akihiro MOTOMOCHI, Shiga (JP)

(72) Inventors: Kei TSUJIMOTO, Shiga (JP); Akihiro MOTOMOCHI, Shiga (JP)

(73) Assignee: Takata Corporation, Tokyo (JP)

(21) Appl. No.: 15/513,236

(22) PCT Filed: Jul. 14, 2015
(86) PCT No.: PCT/JP2015/070173

§ 371 Date: Mar. 22, 2017

(30) Foreign Application Priority Data
Sep. 26, 2014 (JP) 2014-196981

(51) Int. Cl. B60R 21/235; B60R 21/231; B60R 21/217; B60R 21/205; B60R 21/00

(52) U.S. Cl. CPC B60R 21/235; B60R 21/217; B60R 21/231; B60R 21/205; B60R 2021/0048; B60R 2021/006; B60R 2021/2358; B60R 2021/0004

(57) ABSTRACT

A passenger-side airbag includes a first side panel, a second side panel opposite the first side panel, a first center panel having a first side edge part toward the first side panel, a second side edge part opposite the first side edge part, and a first front face situated between the first side edge part and the second side edge part to face an occupant, and a second center panel having a third side edge part toward the second side panel, a fourth side edge part opposite the third side edge part, and a second front face situated between the third side edge part and the fourth side edge part to face an occupant, wherein the second side edge part has a flange projecting in an opposite direction from the first side edge part, and the flange is bonded to the fourth side edge part such that the second front face bulges relative to the first front face.

### TECHNICAL FIELD

The present invention relates to a passenger side airbag and an airbag apparatus having the same.

### BACKGROUND ART

An airbag having a main chamber and a sub-chamber is known in the art (see Patent Document 1, for example).

### RELATED-ART DOCUMENTS

### Patent Document

[Patent Document 1] Japanese Patent Application Publication No. 2-303951

### SUMMARY OF THE INVENTION

### Problem to be Solved by the Invention

The airbag as mentioned above, however, has a relatively narrow conduit through which gas flows from the main chamber to the sub-chamber, which makes it difficult to inflate the sub-chamber in a desired shape.

The object is thus to provide a passenger side airbag and an airbag apparatus having the same which allows part of the panels forming the surface of the airbag to easily bulge in a desired shape.

### Means to Solve the Problem

In one design, a passenger-side airbag is provided that includes a first side panel, a second side panel opposite the first side panel, a first center panel having a first side edge part toward the first side panel, a second side edge part opposite the first side edge part, and a first front face situated between the first side edge part and the second side edge part to face an occupant, and a second center panel having a third side edge part toward the second side panel, a fourth side edge part opposite the third side edge part, and a second front face situated between the third side edge part and the fourth side edge part to face an occupant, wherein the second side edge part has a flange projecting in an opposite direction from the first side edge part, and the flange is bonded to the fourth side edge part such that the second front face bulges relative to the first front face.

### Advantage of the Invention

According to one aspect, part of the panels forming the surface of the airbag can easily bulge in a desired shape.

### BRIEF DESCRIPTION OF DRAWINGS

FIG. 1 is a side elevation view illustrating an example of a vehicle structure as viewed from the opposite side of the passenger seat to the driver's seat in a lateral view.

FIG. 2 is a front view illustrating an example of the configuration of a passenger-side airbag that is inflated and deployed as viewed from an occupant in the passenger seat.

FIG. 3 is a top axonometric view illustrating an example of the configuration of the passenger-side airbag that is inflated and deployed as viewed from the opposite side of the passenger seat to the driver's seat at an elevated viewpoint situated at an angle.

FIG. 4 is a side elevation view illustrating an example of the configuration of the passenger-side airbag that is inflated and deployed as viewed from the opposite side of the passenger seat to the driver's seat in a lateral view.

FIG. 5 is a side elevation view illustrating an example of the configuration of the passenger-side airbag that is inflated and deployed as viewed from the driver's seat side in a lateral view.

FIG. 6 is a plan view of an example of a first side panel.

FIG. 7 is a plan view of an example of a second side panel.

FIG. 8 is a plan view of an example of a first center panel.

FIG. 9 is a plan view of an example of a second center panel.

FIG. 10 is a plan view of an example of a first center panel.

FIG. 11 is a plan view of an example of a second center panel.

FIG. 12 is a plan view of an example of a third center panel.

### MODE FOR CARRYING OUT THE INVENTION

### <Configuration of Vehicle Structure 200 and Airbag Apparatus 100>

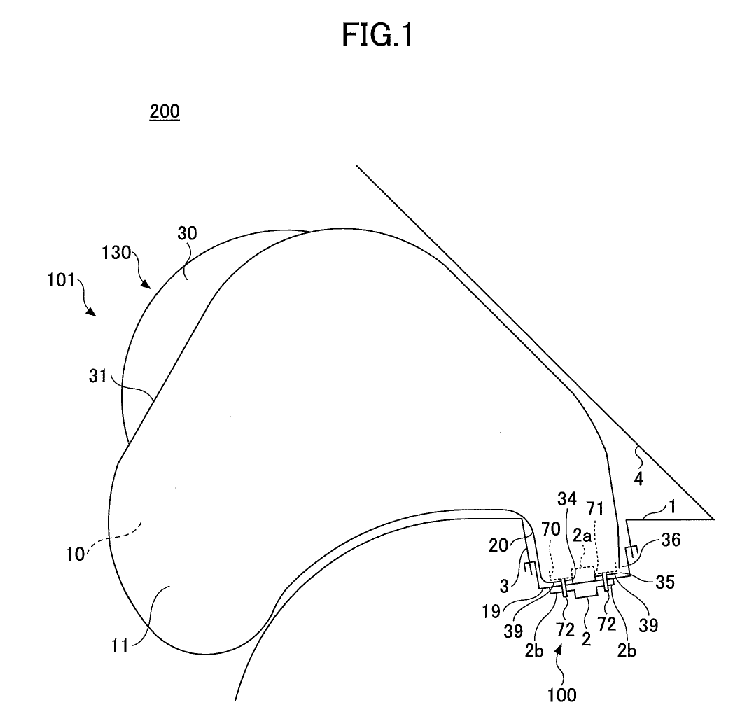

FIG. 1 is a side elevation view of an example of a vehicle structure 200 according to an embodiment as schematically illustrated in a side view taken from the opposite side of the passenger seat to the driver side. This vehicle structure 200 illustrates an example of the vehicle structure used when a driver's seat is situated on the left-hand side of the front row, and the passenger seat is situated on the right-hand side of the front row. The vehicle structure 200 includes an instrument panel 1, a front windshield 4, and a passenger side airbag apparatus 100. FIG. 1 illustrates an example of an airbag 101 of the airbag apparatus 100 in the inflated and deployed state.

The instrument panel 1 is an interior part (also referred to as a dashboard) situated in front of the passenger seat in the vehicle. The front windshield 4, which is a plate member disposed in the front window of the vehicle, is a glass plate inclined toward the vehicle interior space relative to the upper face of the instrument panel 1, for example.

The airbag apparatus 100, which is an example of a passenger protection apparatus for protecting an occupant sitting on the passenger seat, is accommodated in a storage unit 3 disposed in the instrument panel 1. In the inactivated state prior to the inflation and deployment of the airbag 101, the opening face of the storage unit 3 is covered with a cover (not shown) disposed on the instrument panel 1.

The airbag apparatus 100 is an example of a passenger side airbag apparatus including an inflator 2, a retainer 19, and the airbag 101.

The inflator 2 is an example of a gas supply unit (i.e., gas generating unit) for supplying gas for inflating and deploying the airbag 101 based on a control signal from a control circuit (not shown). The inflator 2 includes a cylindrical gas emission part 2a having a gas emission orifice and a flange 2b extending from the lateral surface of the gas emission part 2a. The gas emission part 2a is placed in a mounting hole 34 and a ring hole 71. The mounting hole 34 is a hole formed in the panel surface of the airbag 101. The ring hole 71 is a hole formed in a bag ring 70.

With the gas emission part 2a being placed into the mounting hole 34 and the ring hole 71 and a periphery 39 of the mounting hole 34 being placed between the bag ring 70 and the retainer 19, bolts 72 are used to bolt together the periphery 39, the bag ring 70, the retainer 19, and the flange 2b. With this arrangement, the airbag 101 and the inflator 2 are fastened to the retainer 19. The mechanism for fastening the airbag 101, the inflator 2, and the retainer 19 is not limited to the illustrated structure, and any other fastening structure may be used.

The airbag 101 is an example of a passenger side airbag used when the passenger seat is situated on the right-hand side of the front row. The airbag 101 prior to inflation is accommodated in the retainer 19 inside the storage unit 3 in a folded state that allows subsequent inflation and deployment in response to gas supplied from the inflator 2. The airbag 101, which has a chamber 10 inflated by gas supplied from the inflator 2, pushes open the cover (not shown) disposed on the instrument panel 1 when the chamber 10 inflates, thereby serving as a passenger protecting member that inflates and deploys toward the occupant sitting in the passenger seat. The chamber 10 is an inflating room that is inflated by gas supplied from the inflator 2.

The airbag 101 has a bulge 130 that bulges like a lump toward the occupant at a front face 31 of a center right panel 20. The front face 31 is a panel part facing toward the occupant among the surface of the center right panel 20.

### <Configuration of Airbag 101>

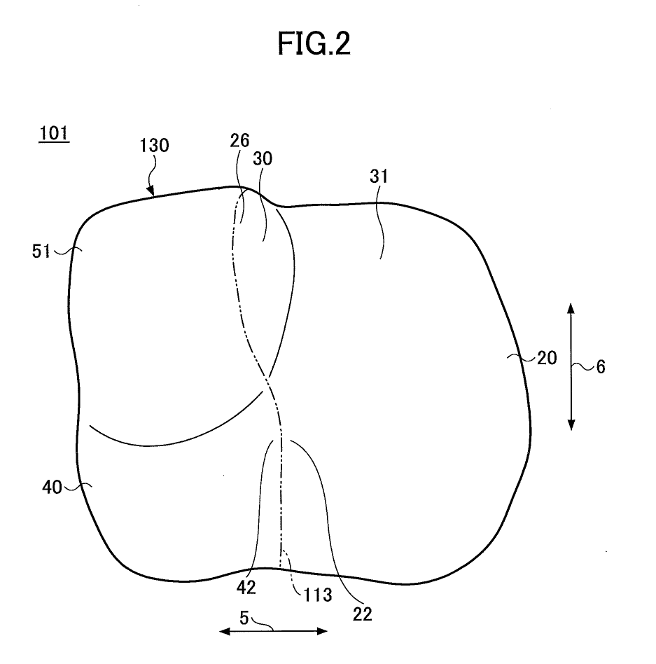

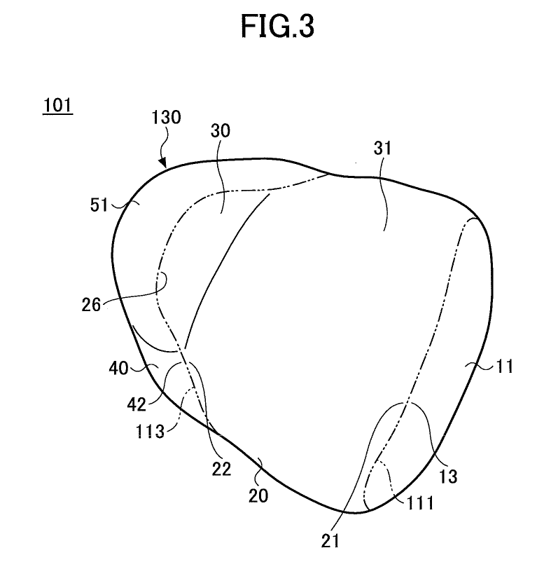

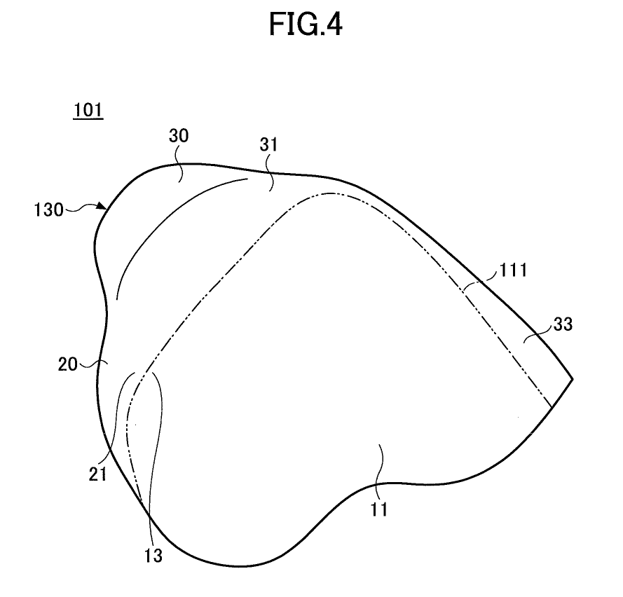

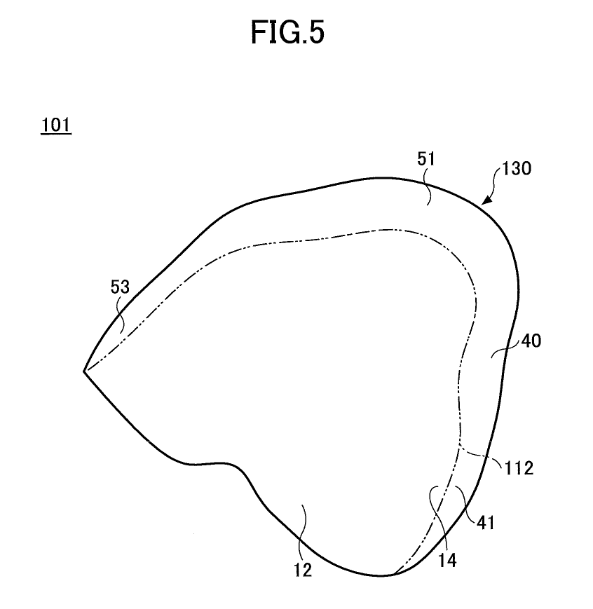

FIG. 2 is a front view illustrating an example of the configuration of the airbag 101 that is inflated and deployed as viewed from the occupant in the passenger seat. A vehicle width direction 5 indicates a left-right direction of the vehicle. A vertical direction 6 indicates a top-bottom direction of the vehicle. FIG. 3 is a top axonometric view illustrating an example of the configuration of the airbag 101 that is inflated and deployed as viewed from the opposite side of the passenger seat to the driver's seat at an elevated viewpoint situated at an angle. FIG. 4 is a side elevation view illustrating an example of the configuration of the airbag 101 that is inflated and deployed as viewed from the opposite side of the passenger seat to the driver's seat in a lateral view. FIG. 5 is a side elevation view illustrating an example of the configuration of the airbag 101 that is inflated and deployed as viewed from the driver's seat side in a lateral view.

As illustrated in FIGS. 2 through 5, the airbag 101 includes a right side panel 11, a left side panel 12, the center right panel 20, and a center left panel 40. The right side panel 11 and the left side panel 12 are a pair of side panels situated side by side in the vehicle width direction 5. The right side panel 11 is situated toward the outside of the vehicle in the vehicle width direction 5. The left side panel 12 is situated toward the inside of the vehicle in the vehicle width direction 5. Namely, the left side panel 12 is situated opposite the right side panel 11 in the vehicle width direction 5. The center right panel 20 and the center left panel 40 is a pair of main panels arranged side by side in the vehicle width direction 5 and bonded together by stitching or the like along a line-shaped bonding portion 113. The center right panel 20 is situated toward the outside of the vehicle in the vehicle width direction 5. The center left panel 40 is situated toward the inside of the vehicle in the vehicle width direction 5.

The right side panel 11, the left side panel 12, the center right panel 20, and the center left panel 40 constitute the surface of the airbag 101. The bulge 130 is formed by a front face 51 of the center left panel 40 that bulges relative to the front face 31 of the center right panel 20.

The center right panel 20 is an example of a first center panel that includes a right edge part 21, a left edge part 22, and the front face 31. The right edge part 21 is the side edge toward the right side panel 11. The left edge part 22 is the side edge opposite the right edge part 21. The front face 31 is a panel surface that is situated between the right edge part 21 and the left edge part 22 to face the occupant.

The center left panel 40 is an example of a second center panel that includes a left edge part 41, a right edge part 42, and the front face 51. The left edge part 41 is the side edge toward the left side panel 12. The right edge part 42 is the side edge opposite the left edge part 41. The front face 51 is a panel surface that is situated between the left edge part 41 and the right edge part 42 to face the occupant.

Each of the front face 31 and the front face 51 is a panel portion that faces toward the occupant (i.e., toward the rear side of the vehicle relative to the airbag 101) when the airbag 101 is inflated and deployed. The airbag 101 inflates and deploys such that the front face 31 more directly faces the occupant in the passenger seat than does the front face 51.

The left edge part 22 of the center right panel 20 has a flange 30 projecting in an opposite direction from the right edge part 21 of the center right panel 20. The flange 30 has a curved portion 26 that is bonded to the right edge part 42 of the center left panel 40 so as to allow the front face to bulge toward the occupant relative to the front face 31. The flange 30 constitutes the side face of the bulge 130 situated toward the right side panel 11. The curved portion 26 is part of the left edge part 22 that constitutes an outline of the flange 30.

The provision of the flange 30 as described above thus allows the bulge 130 to be easily formed to bulge relative to the front face 31.

### <Configuration of Each Panel of Airbag 101>

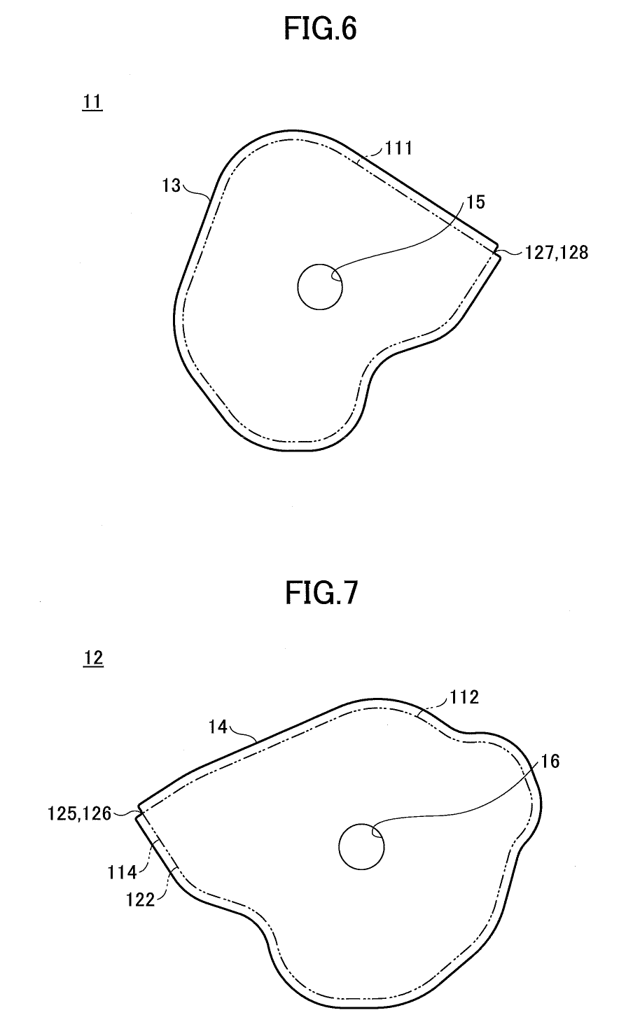

FIG. 6 is a plan view of an example of the right side panel 11. The right side panel 11 has a perimeter 13. The right side panel 11 is an example of a first side panel having a first perimeter, and the perimeter 13 is an example of the first perimeter. The right side panel 11 is a single foundation cloth having a rounded polygonal sheet shape. The right side panel 11 may have at least one vent hole 15. The vent hole 15 is an opening that enables the exhaustion of gas from the camber 10 to the outside of the camber 10.

FIG. 7 is a plan view of an example of the left side panel 12. The left side panel 12 has a perimeter 14. The left side panel 12 is an example of a second side panel having a second perimeter whose length is longer than the length of the first perimeter, and the perimeter 14 is an example of the second perimeter. The left side panel 12 is a single foundation cloth having a rounded polygonal sheet shape. The left side panel 12 may have at least one vent hole 16. The vent hole 16 is an opening that enables the exhaustion of gas from the camber 10 to the outside of the camber 10.

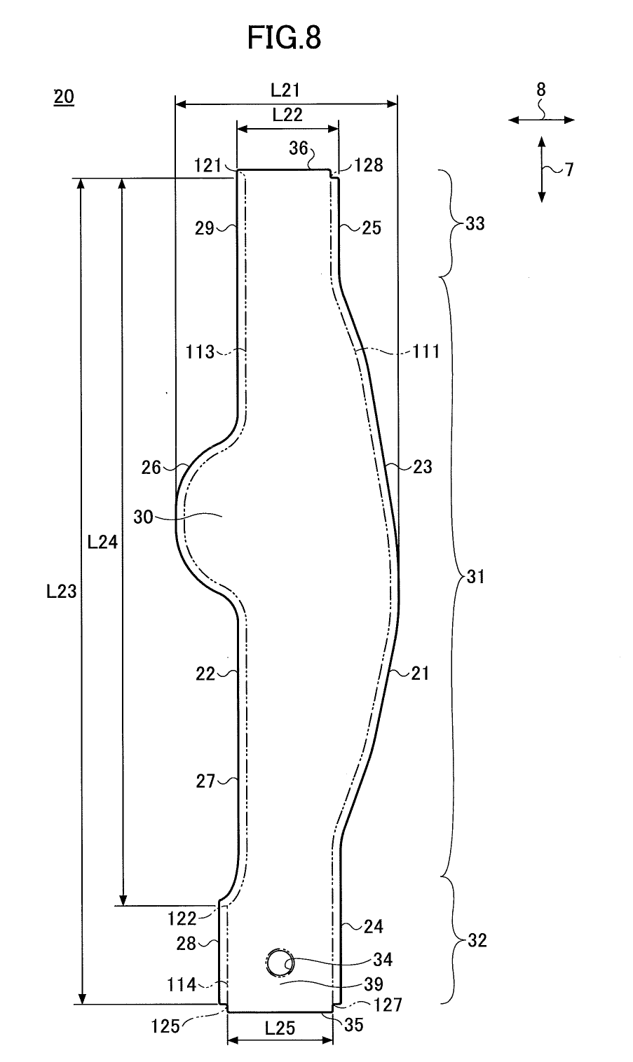

FIG. 8 is a plan view of an example of the center right panel 20. The center right panel 20, which is a single sheet-shaped foundation cloth, is an example of a first strip-shaped center panel. The center right panel 20 includes the right edge part 21, the left edge part 22, a pair of ends 35 and 36, the front face 31, a bottom face 32, and a top face 33.

The front face 31 is part of the panel surface that faces the occupant upon the inflation of the chamber 10. The bottom face 32 is part of the panel surface that will be situated at the bottom of the airbag 101 upon the inflation of the chamber 10. The top face 33 is part of the panel surface that will be situated on the same side of the airbag 101 as the front windshield 4 upon the inflation of the chamber 10.

The right edge part 21 extends in a longitudinal direction 7 of the center right panel from the one end 35 to the other end 36. The right edge part 21 is a side edge situated on one side in a width direction 8 of the center right panel 20. The right edge part 21 is an example of a first side edge bonded to the perimeter 13 of the right side panel 11 along a line-shaped bonding portion 111 by stitching or the like so as to circle around the perimeter 13 (see FIGS. 3, 4, and 6).

The bonding portion 111 is such that the right edge part 21 of the center right panel 20 and the perimeter 13 of the right side panel 11 are bonded to each other by stitching or the like from a bonding end 128 to a bonding end 127. Namely, the length of the line-shaped bonding portion 111 from the bonding end 128 of the right edge part 21 to the bonding end. 127 of the right edge part 21 is equal to the perimeter length along the line-shaped bonding portion 111 extending from the bonding end 128 of the perimeter 13 to the bonding end 127 of the perimeter 13.

The left edge part 22 extends in a longitudinal direction 7 of the center right panel 20 from the one end 35 to the other end 36. The left edge part 22 is a side edge opposite from the right edge part 21 in the width direction 8 of the center right panel 20. The left edge part 22 is an example of a second side edge that is bonded to the right edge part 42 of the center left panel 40 (see FIGS. 2, 3, and 9) by stitching or the like along a line-shaped bonding portion 113. A straight portion 28 of the left edge part 22 is bonded to part of the perimeter 14 of the left side panel 12 (see FIG. 7) by stitching or the like along a line-shaped bonding portion 114.

The bonding portion 113 is such that the left edge part 22 of the center right panel 20 and the right edge part 42 of the center left panel 40 are bonded to each other by stitching or the like from a first bonding end 121 to a second bonding end 122. Namely, the length of the line-shaped bonding portion 113 from the bonding end 121 of the left edge part 22 to the bonding end 122 of the left edge part 22 is equal to the length of the line-shaped bonding portion 113 extending from the bonding end 121 of the right edge part 42 to the bonding end 122 of the right edge part 42.

The bonding portion 114 is such that part of the left edge part 22 of the center right panel (i.e., the straight portion 28 in the case of the illustration) and part of the perimeter 14 of the left side panel 12 are bonded to each other by stitching or the like from the bonding end 122 to a bonding end 125. Namely, the length of the line-shaped bonding portion 114 from the bonding end 122 of the left edge part 22 to the bonding end 125 of the left edge part 22 is equal to the length of the line-shaped bonding portion 114 extending from the bonding end 122 of the perimeter 14 to the bonding end 125 of the perimeter 14.

The end 35 is one end of the center right panel 20 in the longitudinal direction 7. The end 36, which is the other end of the center right panel in the longitudinal direction 7, is situated opposite from the end 35 in the longitudinal direction 7.

In FIG. 8, the front face 31, which is an example of a middle part of the center right panel in the longitudinal direction 7, is situated between the bottom face 32 and the top face 33. The bottom face 32 and the top face 33 are connected to the ends of the front face 31 in the longitudinal direction 7. The bottom face 32 extends from the front face 31 toward the end 35 in the longitudinal direction 7, and the top face 33 extends from the front face 31 to the end 36 in the longitudinal direction 7. The bottom face 32 has the mounting hole 34 into which the gas emission part 2a of the inflator 2 is inserted.

The front face 31 is wider than the bottom face 32 or the top face 33 in the width direction 8 of the center right panel 20, for example. A width L21 of the front face 31 is wider than a width L25 of the bottom face 32 and a width L22 of the top face 33, for example. The width L25 is wider than the width L22. The front face 31 serves as a portion to receive the head (especially, the face) of the occupant in the passenger seat at the time of inflation and deployment of the airbag 101. Accordingly, the wider width of the front face 31 in the width direction 8 than the bottom face 32 and the top face 33 allows the head of the occupant in the passenger seat to be reliably supported.

The right edge part 21 of the front face has a curved portion 23 extending rightwards relative to the right edge part 21 of the bottom face 32 and the top face 33, for example. For example, the right edge part 21 of the bottom face 32 has a straight portion 24, and the right edge part 21 of the top face 33 has a straight portion 25. The curved portion 23 extends to the right relative to the straight portions 24 and 25.

The left edge part 22 of the front face 31 has the curved portion 26 extending leftwards relative to the left edge part 22 of the bottom face 32 and the top face 33. For example, the left edge part 22 of the bottom face 32 has the straight portion 28 parallel to the straight portion 24, and the left edge part 22 of the top face 33 has a straight portion 29 parallel to the straight portion 25. The left edge part 22 of the front face 31 has a straight portion 27 parallel to the straight portion 28, for example. The curved portion 26 extends to the left relative to the straight portions 27, 28, and 29.

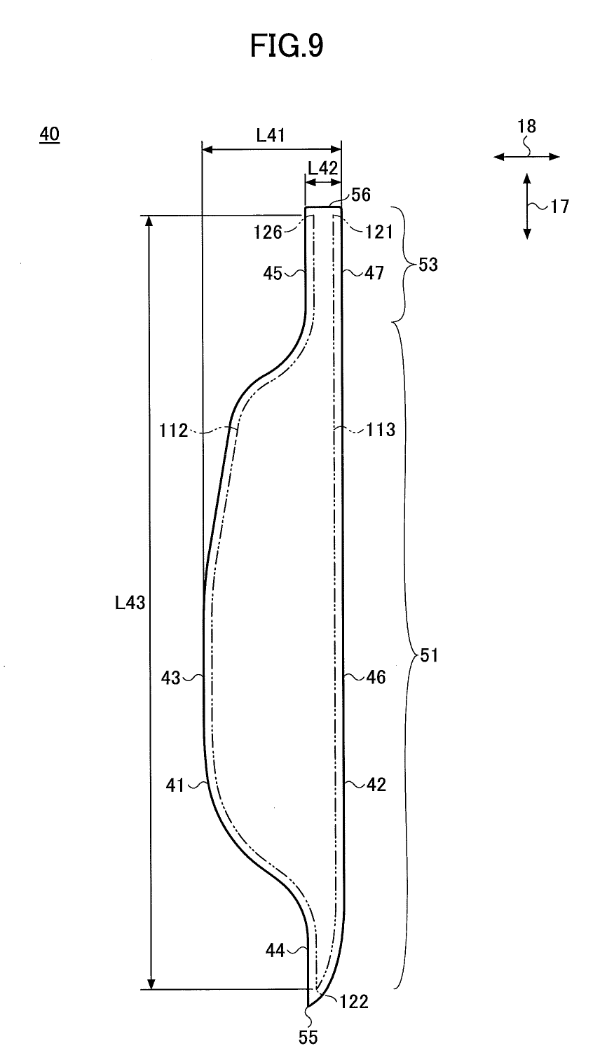

FIG. 9 is a plan view of an example of the center left panel 40. The center left panel 40, which is a single sheet-shaped foundation cloth, is an example of a second strip-shaped center panel. The center left panel 40 includes the left edge part 41, the right edge part 42, a pair of ends 55 and 56, the front face 51, and a top face 53.

The front face 51 is part of the panel surface that faces the occupant upon the inflation of the chamber 10. The top face 53 is part of the panel surface that will be situated at the top of the airbag 101 upon the inflation of the chamber 10.

The left edge part 41 extends in a longitudinal direction 17 of the center left panel 40 from the one end 55 to the other end 56. The left edge part 41 is a side edge situated on one side in a width direction 18 of the center left panel 40. The left edge part 41 is an example of a third side edge bonded to the perimeter 14 of the left side panel 12 along a line-shaped bonding portion 112 by stitching or the like so as to circle around the perimeter 14 (see FIGS. 5 and 7).

The bonding portion 112 is such that the left edge part 41 of the center left panel 40 and the perimeter 14 of the left side panel 12 are bonded to each other by stitching or the like from a bonding end 126 to a bonding end 122. Namely, the length of the line-shaped bonding portion 112 from the bonding end 126 of the left edge part 41 to the bonding end 122 of the left edge part 41 is equal to the length of the line-shaped bonding portion 112 extending from the bonding end 126 of the perimeter 14 to the bonding end 122 of the perimeter 14.

The right edge part 42 extends in the longitudinal direction 17 of the center left panel from the one end 55 to the other end 56. The right edge part 42 is a side edge opposite from the left edge part 41 in the width direction 18 of the center left panel 40. The right edge part 42 is an example of a fourth side edge that is bonded to the left edge part 22 of the center right panel 20 (see FIGS. 2, 3, and 8) by stitching or the like along the line-shaped bonding portion 113.

In FIG. 9, the end 55 is one end of the center left panel 40 in the longitudinal direction 17. The end 56, which is the other end of the center left panel 40 in the longitudinal direction 17, is situated opposite from the end 55 in the longitudinal direction 17.

The front face 51, which is an example of a middle part of the center left panel 40 in the longitudinal direction 17, is situated between the pair of ends 55 and 56. The top face 53 is connected to one side of the front face 51 in the longitudinal direction 17. The top face 53 extends from the front face 51 toward the end 56 in the longitudinal direction 17.

The left edge part 41 of the front face 51 has a curved portion 43 extending leftwards relative to the left edge part 41 of the top face 53. For example, the left edge part 41 of the top face 53 has a straight portion 45. The left edge part 41 of the front face 51 has a straight portion 44, for example. The curved portion 43 extends to the left relative to the straight portions 44 and 45.

For example, the right edge part 42 of the front face 51 has a straight portion 46 parallel to the straight portion 44, and the right edge part 42 of the top face 53 has a straight portion 47 parallel to the straight portion 45. The straight portion 46 and the straight portion 47 are on the same straight line as illustrated, for example.

In FIG. 8, the left edge part 22 of the front face 31 has the flange 30 projecting in an opposite direction from the right edge part 21 in the width direction 8. The outline of the flange 30 corresponds to the substantially semicircular curved portion 26. The straight portion 46 of the right edge part 42 in FIG. 9 is bonded via the line-shaped bonding portion 113 along the curved portion 26.

FIGS. 8 and 9 are drawings illustrating plan views (which will hereinafter be referred to as plan views A) prior to the bonding of the left edge part 22 of the center right panel 20 and the right edge part 42 of the center left panel 40 along the bonding portion 113 from the bonding end 121 to the bonding end 122. In FIG. 9, a length L43 designates the length of the longitudinal-direction component of the center left panel 40 (i.e., the component in the longitudinal direction 17) from the bonding end 121 of the right edge part 42 to the bonding end 122 of the right edge part 42 in the plan view A. In FIG. 8, a length L24 designates the length of the longitudinal-direction component of the center right panel 20 (i.e., the component in the longitudinal direction 7) from the bonding end 121 of the left edge part 22 to the bonding end 122 of the left edge part 22 in the plan view A. In FIG. 8, a length L23 designates the length of the longitudinal-direction component of the center right panel 20 (i.e., the component in the longitudinal direction 7) from the bonding end 121 of the left edge part 22 to the bonding end 125 of the left edge part 22 in the plan view A. The length L43 is longer than the length L24. The length L24 is longer than the length L23.

Since the length L43 is longer than the length L24 and the left edge part 22 has the flange 30, bonding the left edge part 22 and the right edge part 42 to each other along the line-shaped bonding portion 113 from the bonding end 121 to the bonding end 122 causes the center left panel 40 to be bonded in a curved state to the center right panel 20. The length of the perimeter 14 of the left side panel 12 that is bonded to the left edge part 41 of the center left panel 40 is longer than the length of the perimeter 13 of the right side panel 11 that is bonded to the right edge part 21 of the center right panel 20.

The left edge part 22 and the right edge part 42 are bonded to each other along the bonding portion 113. The right edge part 21 is bonded to the perimeter 13 along the bonding portion 111. The left edge part 41 is bonded to the perimeter 14 along the bonding portion 112. The straight portion 28 and part of the perimeter 14 are bonded to each other along the bonding portion 114. At the end, the end 35 and the ends 36 and 56 are bonded. Performing the bonding steps as described above allows the single chamber 10 to be easily formed in the airbag 101. Further, bonding the plurality of panels to form the airbag 101 allows the bulge 130 to easily bulge in a desired shape when the airbag 101 is inflated and deployed.

Further, even if the head of the occupant moves at an angle toward the center instrument panel due to inertia upon the impact of the vehicle at an angle or with an offset, the inflated, deployed airbag 101 is able to receive the face of the occupant at the front face 31 and also to receive the temporal region and back side of the head at the side face of the bulge 130. The center instrument panel is an interior part between the interior part situated in front of the passenger seat and the interior part situated in front of the driver's seat. The side face of the bulge 130 refers to the panel surface formed by the flange 30 of the center right panel 20. Receiving the temporal region and back side of the head of the occupant at the side face of the bulge 130 serves to suppress the rotation of the head of the occupant, for example.

### <Another Configuration of Each Panel of Airbag 101>

In the following, a description will be given of another configuration of each panel of the airbag 101 that is different from the above-described configuration. It may be noted that the same or similar configurations as the panels described above are referred to by the same numerals, and a description thereof will be omitted or simplified.

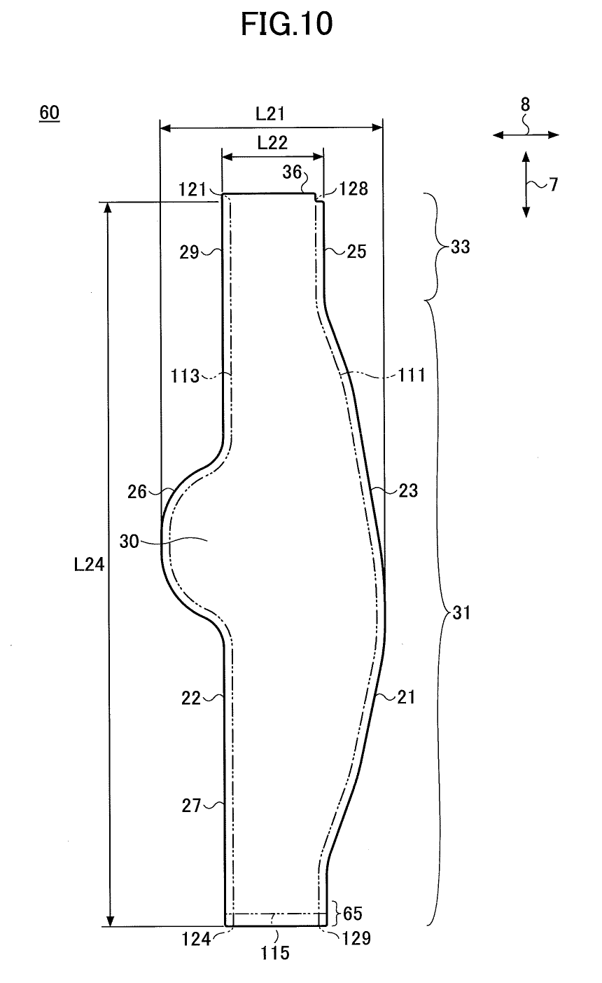

FIG. 10 is a plan view of an example of a center right panel 60. The center right panel 60, which is a single sheet-shaped foundation cloth, is an example of a first strip-shaped center panel. The center right panel 60 includes the front face 31 and the top face 33. The left edge part 22 has the flange 30 projecting in the opposite direction from the right edge part 21.

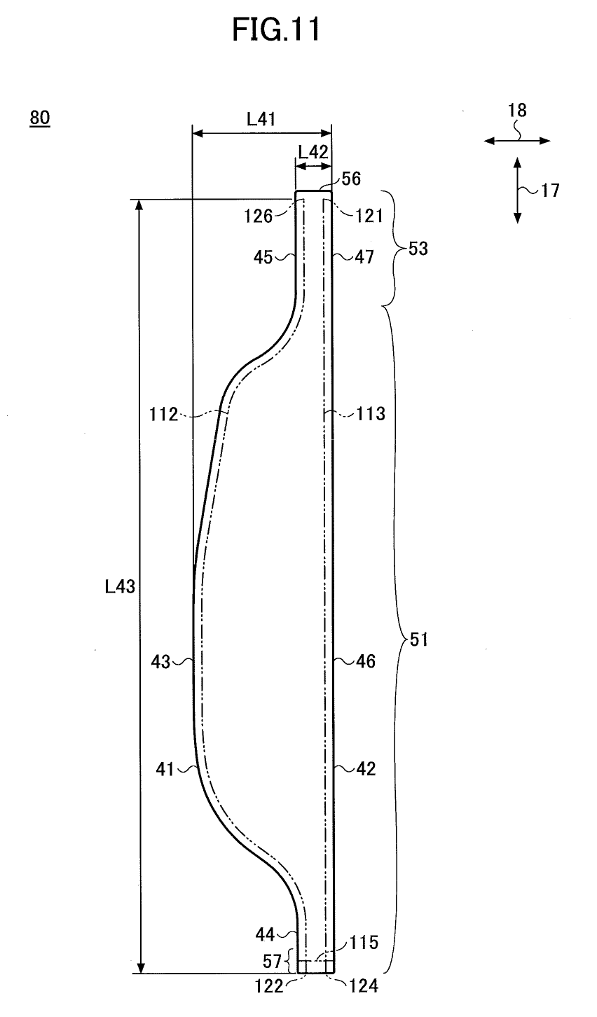

FIG. 11 is a plan view of an example of a center left panel 80. The center left panel 80, which is a single sheet-shaped foundation cloth, is an example of a second strip-shaped center panel. The center left panel 80 includes the front face 51 and the top face 53.

The bonding portion 113 is such that the left edge part 22 of the center right panel 60 and the right edge part 42 of the center left panel 80 are bonded to each other by stitching or the like from the bonding end 121 to the bonding end 124. Namely, the length of the line-shaped bonding portion 113 from the bonding end 121 of the left edge part 22 to the bonding end 124 of the left edge part 22 is equal to the length of the line-shaped bonding portion 113 extending from the bonding end 121 of the right edge part 42 to the bonding end 124 of the right edge part 42.

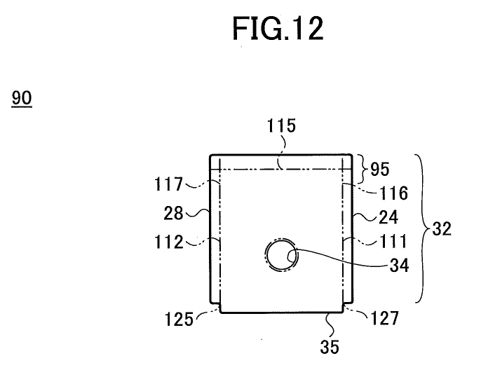

FIG. 12 is a plan view of an example of a mouth panel 90. The mouth panel 90, which is a single sheet-shaped foundation cloth, is an example of a third center panel bonded to at least the first center panel. The mouth panel 90 has the mounting hole 34 to which the inflator 2 is mountable. The mouth panel 90 is a foundation cloth corresponding to the bottom face 32 of the center right panel 20 illustrated in FIG. 8.

An end 95 of the mouth panel 90 overlaps both an end 65 of the center right panel 60 and an end 57 of the center left panel 80, and is bonded thereto by stitching or the like via a line-shaped bonding portion 115. At the time of bonding along the bonding portion 115, a bonding end 129 of the end 65 is aligned to a bonding point 116 of the end 95, and the bonding end 122 of the end 57 is aligned to a bonding point 117 of the end 95.

FIGS. 10 and 11 are drawings illustrating plan views (which will hereinafter be referred to as plan views B) prior to the bonding of the left edge part 22 of the center right panel 60 and the right edge part 42 of the center left panel 80 along the bonding portion 113 from the bonding end 121 to the bonding end 124. In FIG. 11, a length L43 designates the length of the longitudinal-direction component of the center left panel 80 (i.e., the component in the longitudinal direction 17) from the bonding end 121 of the right edge part 42 to the bonding end 124 of the right edge part 42 in the plan view B. In FIG. 10, a length L24 designates the length of the longitudinal-direction component of the center right panel 60 (i.e., the component in the longitudinal direction 7) from the bonding end 121 of the left edge part 22 to the bonding end 124 of the left edge part 22 in the plan view B. The length L43 is longer than the length L24.

The panels are bonded via the bonding portions 111, 112, 113, and 115. At the end, the end 35 and the ends 36 and 56 are bonded. Performing the bonding steps as described above allows the single chamber 10 to be easily formed in the airbag 101 in a similar manner to before. Further, bonding the plurality of panels to form the airbag 101 allows the bulge 130 to easily bulge in a desired shape when the airbag 101 is inflated and deployed. Also, similarly to before, receiving the temporal region and back side of the head of the occupant at the side face of the bulge 130 serves to suppress the rotation of the head of the occupant, for example.

Although a passenger-side airbag and an airbag apparatus provided therewith have been described by referring to one or more embodiments, the present invention is not limited to these embodiments. Various modifications and improvements such as combining or replacing an embodiment partially or entirely with one or more other embodiments may be made without departing from the scope of the present invention.

For example, the airbag of the present embodiment may be used as a passenger-side airbag in the case in which the driver's seat is situated on the right in the front row, and the passenger seat is situated on the left in the front row.

In the embodiments previously described, the bulge 130 is disposed toward the inner-side side panel in the vehicle width direction so as to be able to reliably receive the head of the occupant that may be moving at an angle toward the center instrument panel. Nonetheless, the bulge 130 may be disposed toward the outer-side side panel in the vehicle width direction. With this arrangement, the bulge 130 is reliably able to receive the head of the occupant that is moving at an angle toward the A pillar.

The airbag of the present embodiment is not limited to the configuration in which the length L43 is longer than the length L24, and may be directed to the configuration in which the length L43 is shorter than the length L24.

Further, two or more mounting holes 34 to which the inflator 2 is mountable may be provided so as to allow two or more inflators 2 to be used to inflate the chamber 10. A wall for regulating gas flow may be disposed inside the chamber 10 such as to change the time for the front face 31 and the bulge 130 to project the furthest from the mounting hole 34. Changing the timing or the amount (output quantity) of gas supply to the chamber 10 between the inflators enables a change to be made to the time for the front face 31 and the bulge 130 to project the furthest from the mounting hole 34, for example.

This international application claims foreign priority to Japanese Patent Application No. 2014-196981 filed on Sep. 26, 2014, the entire contents of which are incorporated herein by reference.

### DESCRIPTION OF REFERENCE SYMBOLS

1 instrument panel
2 inflator
2a gas emission part
2b flange
3 storage unit
4 front windshield
5 vehicle width direction
6 vertical direction
7, 17 longitudinal direction
8, 18 width direction
10 chamber
11 right side panel (example of first side panel)
12 left side panel (example of second side panel)
13 perimeter (example of first perimeter)
14 perimeter (example of second perimeter)
15, 16 vent hole
19 retainer
20 center panel (example of first center panel)
21 right edge part (example of first edge part)
22 left edge part (example of second edge part)
23, 26 curved portion
24, 25, 27, 28, 29 straight portion
30 flange
31 front face (example of first front face)
32 bottom face
33 top face
34 mounting hole
35, 36 end
39 periphery
40 center panel (second center panel)
41 left edge part (example of third edge part)
42 right edge part (example of fourth edge part)
43 curved portion
44, 45, 46, 47 straight portion
51 front face (example of second front face)
53 top face
55, 56, 57 end
60 center panel (example of first center panel)
65 end
70 bag ring
71 ring hole
72 bolts
80 center panel (example of second center panel)
90 mouth panel (example of mounting panel)
95 end
100 airbag apparatus
101 passenger-side airbag
111, 112, 113, 114, 115 bonding portion
116, 117 bonding point
121, 122, 124, 125, 126, 127, 128, 129 bonding end
130 bulge
200 vehicle structure

1. A passenger-side airbag, comprising:
a first side panel;
a second side panel opposite the first side panel;
a first center panel having a first side edge part toward the first side panel, a second side edge part opposite the first side edge part, and a first front face situated between the first side edge part and the second side edge part to face an occupant; and
a second center panel having a third side edge part toward the second side panel, a fourth side edge part opposite the third side edge part, and a second front face situated between the third side edge part and the fourth side edge part to face an occupant,
wherein the second side edge part has a flange projecting in an opposite direction from the first side edge part, and
the flange is bonded to the fourth side edge part such that the second front face bulges relative to the first front face.

2. The passenger-side airbag as claimed in claim 1, wherein the first side panel has a first perimeter bonded to the first side edge part, and the second side panel has a second perimeter bonded to the third side edge part, a length of the second perimeter being longer than a length of the first perimeter.

3. The passenger-side airbag as claimed in claim 2, wherein the first side edge part is bonded to the first perimeter so as to circle around the first perimeter, and the third side edge part is bonded to the second perimeter so as to circle around the second perimeter.

4. The passenger-side airbag as claimed in claim 3, further comprising a bonding portion to bond the second side edge part and the fourth side edge part to each other from a first bonding end to a second bonding end, wherein a length of a longitudinal direction component of the second center panel from the first bonding end of the fourth side edge part to the second bonding end of the fourth side edge part is longer than a length of a longitudinal direction component of a first center panel from the first bonding end of the second side edge part to the second bonding end of the second side edge part in a plan view prior to bonding the second side edge part and the fourth side edge part to each other from the first bonding end to the second bonding end.

5. The passenger-side airbag as claimed in claim 4, wherein the fourth side edge part has a straight portion bonded to the flange in the plan view.

6. The passenger-side airbag as claimed in claim 1, wherein the first center panel has a mounting hole to which a gas supply unit is mountable, the gas supply unit supplying gas for inflating the passenger-side airbag.

7. The passenger-side airbag as claimed in claim 1, further comprising a third center panel having a mounting hole to which a gas supply unit is mountable, the gas supply unit supplying gas for inflating the passenger-side airbag, wherein the third center panel is at least bonded to the first center panel.

8. An airbag apparatus, comprising:
a passenger-side airbag of claim 1; and
a bas supply unit to supply gas for inflating the passenger-side airbag.
